(19) United States
(12) Patent Application Publication
(10) Pub. No.: US 2020/0369414 A1
(43) Pub. Date: Nov. 26, 2020

(54) PORTABLE SANDBAG FILLING MACHINE

(71) Applicant: Sandbag Store, LLC, Las Vegas, NV (US)

(72) Inventors: Christopher Haas, Las Vegas, NV (US); Steve Burcham, Las Vegas, NV (US)

(21) Appl. No.: 16/588,681

(22) Filed: Sep. 30, 2019

Related U.S. Application Data
(60) Provisional application No. 62/851,535, filed on May 22, 2019.

(51) Int. Cl. B65B 1/06; B65B 7/02; B65G 47/44

(52) U.S. Cl. CPC B65B 1/06; B65G 2201/045; B65G 47/44; B65B 7/02

(57) ABSTRACT

A portable sandbag and aggregate bag filling machine that may be readily loaded in a shipping container or truck and shipped along the less-than-truckload (LTL) road and transport system network. The sandbag filling machine is designed to fit entirely within a shipping container without disassembly into component parts. The machine is sufficiently compact with minimized height to allow a complete and operable gravity-fed hopper and operable ascending horizontal sand feeder belt machinery suitable for optimized sand handling to be included in a working and deliverable unit sufficiently small to be placed and transported in a shipping container or truck trailer.

### CROSS-REFERENCE TO RELATED APPLICATIONS

The present application is related to U.S. Provisional Patent Application No. 62/851,535, filed on May 22, 2019, which is hereby incorporated in its entirety.

### BACKGROUND

The disclosed embodiments relate to portable sandbag filling machines. More specifically, the disclosed embodiments relate to sandbag filling machines that may be loaded into shipping containers and then onto trucks and other common carrier vehicles for transport via the LTL (less-than-truckload) network.

As recent large-scale natural disasters, including hurricanes and tsunamis, will indicate, there is a pronounced need for first responders to be able to fill and place large quantities of sandbags on-site, e.g., to establish secure perimeters, to minimize storm flow and storm damage, and to facilitate recovery and response on-site where the disasters strike. FEMA and other emergency authorities may need to send a dozen or more filling machines to a single site of flooding or other crisis site. In emergency and in non-emergency efforts, Contractors often move from project to project filling bags on the job sites. In other non-emergency practice, aggregate (including sand) companies usually have multiple mining pits and crushing plants, and will share their bagging machines among their divisions in various locales. As a result, the demand for mobile bag filling machines has led to the develop of such machines that are portable, i.e., trailer-mounted or trailer-mountable bag filling devices.

Thus, there is a present need for a sand and aggregate bag filling machines that may be readily transported in shipping containers and/or in freight trucks and conveyed among general common carrier vehicles along the LTL (less-than-truckload) road and transport network. There is also a present need for advanced methods that accelerate the rate of filling sandbags and reduce the incidence of machine blockage and system stoppage. The present invention serves to satisfy these needs in a new and unexpectedly advantageous way, particularly in that the present invention can facilitate production of more than 10 times the number of filled bags of previous conventional approaches while using far fewer workers.

### SUMMARY

Machines specialized for filling sandbags conventionally use one or more developed methods for handling and packing sand. The efficient bagging of sand and aggregate requires special attention and precision in the starting and stopping of the flow of sand. One conventional approach, relying upon gravity, to fill sandbags, involves a large v-shaped hopper or container. In these instances, gravity will force the unbounded sand to feed out of an aperture or opening at the bottom-most section of the hopper and into receiving sandbags.

Additional force in settling and pouring sand into the bag can be applied by mechanical agitation or vibration of the hopper to shift and move sand material down and out of the bottom aperture of the hopper. In some embodiments, a vibrating pan can be used to feed material from the bottom of the hopper into a sandbag. Such vibrating pans may be more commonly used in situations requiring a highly precise measurement of sand mass or volume. These pans operate such that the sand material will flow while the pan vibrates, and will correspondingly cease to flow when the pan stops vibrating. While capable of high precision, such vibratory pans devices are typically among the slowest mechanisms for filling sandbags and are generally not used for high volume or high-speed bag filling purposes.

In another conventional approach to filling sandbags, large corkscrews, or augers, optionally powered by hydraulic motors, may be used to push sand from the bottom of the hopper horizontally toward a pipe output. As the auger turns, sand dispenses from the pipe output, and this flow of sand will cease as the auger movement stops. The auger method of filling sandbags is faster than the use of vibratory pans, but is a slower process than the use of conveyor or direct gravity-fed methods of filling sandbags, as is described below.

Another conventional approach to filling sandbags is through the use of a conveyor belt. In this method, flexible rubber belting operates on a loop extending between two rollers. As the roller turns, the belt moves. Placed beneath a hopper for sand, the operating conveyor will move sand and aggregate material in operation toward an output sandbag receptacle. The flow of sand will cease when the rollers stop turning. The speed of filling sandbags with this method is contingent strictly open the amount of aggregate material (sand or similar material) on the belt and the screed, that is, distance from the bottom of the hopper storage area, along the belt, to the sandbag receptacle.

A further conventional approach to filling sandbags makes use of direct gravity feed. In this method, the bottom of the aggregate storage hopper is fitted with an output pipe smaller than the opening of the output receptacle sandbag. An output gate from the hopper intermittently opens and closes, allowing the sand to flow into the sandbag when the gate is in the open position, while the flow of sand ceases when the gate closes. This direct gravity method of feeding and filling sandbags is fast and efficient.

Even as there are multiple approaches to filling sandbags, these techniques are not without shortcomings. Even advanced machines specifically designed to fill sandbags cannot handle sand in all conditions and situations. Sand, and other aggregate materials, often become sticky and clump together when wet, and sand being used for filling sandbags is often found to be wet in those situations where sandbags are most critically and urgently needed. Conventional V-shaped hoppers may encounter the unfortunate situation where sand compacts at the bottom of the hopper and creates a sand bridge blocking the bottom hopper opening or aperture, preventing sand in the hopper from exiting the hopper and filling the sandbags beneath. Such a sand bridge can block a span of 8 inches or more, regardless of hopper vibration or other measures taken designed to prevent such bridge formation.

To overcome this sand bridge problem, an auger would need to be at least 8 inches in diameter to ensure that the sand cannot bridge above it. Another effort would be to provide a hopper bottom opening of greater than 8 inches square to allow for gravity-feed out. Even these remedies are inconvenient and may create other problems as a result. In any event, this problem of sand bridging in the feeding hopper causes direct gravity-feed and auger-driven sandbag filling machines to be inconsistent and often unreliable in their performance. Typically, a person or crew member will be required to constantly shovel sand inside of the hopper to ensure proper performance of the sandbag filling machine.

With the present invention, this sand bridge blockage problem is resolved through the development of open hopper bottoms of at least 10 inches by 18 inches in size. This enlarged opening mitigates and often practically eliminates the problem of flow issues caused by wet sand bridge blockage of the opening. As this hopper opening size is larger than all standard sandbag opening sizes, the use of the improved hopper opening precludes the use of a direct gravity feed design. Instead, the present invention makes use of a conveyor to relay the sand from the hopper to the sandbag.

Another problem confronting designers and users of sandbag filling machines is the issue that sandbags must be sealed to retain the sand within. As a general practice, tie strings are commonly attached to sandbags so that users may tie the sandbag tops closed after they have been filled. For most users, it takes about thirty seconds to tie an individual bag closed using its tie strings. In the meantime, our sandbag filling machine can fill a new sandbag at a rate of about one per every two seconds. At thirty seconds per bag to close and seal the bag, the number of filled sandbags in production can rapidly and vastly outnumber the number of closed or sealed bags, overwhelm the production line, and often halt the ability of the production line to operate.

With the present invention, this production capacity problem is solved with an innovative approach. In a present embodiment, the sandbag filling machine uses another, second conveyor belt to run filled sandbags through an in-line sewing machine. The present invention uses such a sewing machine that operates at the same rate as the sandbags are filled, i.e., the present invention sews an individual bag at a rate of one bag every two seconds. This prevents having a backlog of filled sandbags awaiting to be sealed forcing production to slow or cease.

After being sealed and sewn closed, the finished sandbags of the present invention are conveyed to a separate palletizing station where the newly filled and sealed sandbags may be stacked onto a pallet at a rate of one every two seconds. This feature and this process allows the sandbag filling effort to maintain a fast and effective flow of operation and high capacity without becoming overwhelmed or subjected to profound inefficiencies of process.

The ability to deploy sandbag filling machines readily to distant worksites is hampered by the factor that most sandbag filling machines are not easily configured for ready transport by common carrier means and are often not easy to set up without the use of tools particular to the purpose.

In the present invention, the sandbag filling machine has been designed and configured to fit perfectly within the size constraints of a shipping container. Furthermore, the height, width and length of the present sandbag filling machine are sized and configured so that the machine may be readily handled and safely moved by pallet jacks and fork lifts and the filling machine is well-suited for use and conveyance in the LTL (less-than-truckload) network system. The sandbag filling machine can be transitioned through roll-up truck doors into common carrier vehicles and the overall sandbag filling machine fits within the weight limitations of the LTL network system.

To facilitate the easy and ready transport of the sandbag filling machine of the present invention, the conveyor belt is retractable and the conveyor/sewing table is collapsible so as to fit under the retractable conveyor feeder belt within the transportable cubical structure of the sandbag filling machine. With these advances, the present invention is perfectly suited to transport and perform at worksites where the demand for fast and effective sandbag filling performance is paramount.

### BRIEF DESCRIPTION OF THE DRAWINGS

FIG. 1 is a front view of the portable sandbag filling machinery, according to an exemplary embodiment, in a deployed for operation configuration.

FIG. 2 is a front view of the portable sandbag filling machinery apparatus, according to an exemplary embodiment, in a packed or retracted configuration to minimize volume and minimize risk for structural damage in storage or transport uses.

These components in the figures are not necessarily to scale, emphasis instead being placed upon illustrating the principles of the invention. In the figures, identical reference numerals may designate corresponding parts throughout the different views.

### DETAILED DESCRIPTION OF EMBODIMENTS

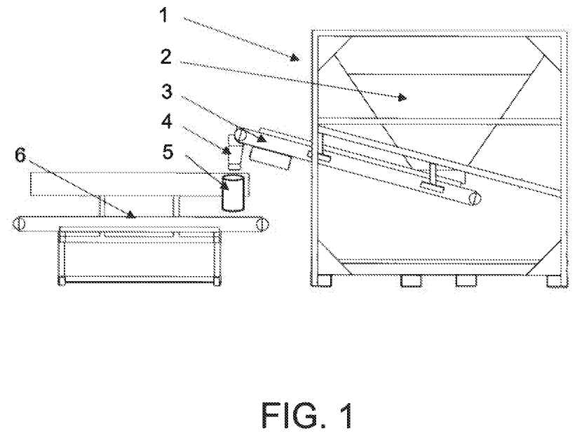

FIG. 1 is a front view of the portable sandbag filling machinery apparatus according to an exemplary embodiment. FIG. 1 depicts the sandbag filling machine apparatus in a deployed and operable configuration. In FIG. 1, the portable sandbag filling machine 1 features a frame structure that supports an input hopper 2 for receiving sand, a retractable conveyor belt 3 that receives and transports the sand provided through the input hopper 2, a conical funnel or spout 4 that collects sand input from the retractable conveyor belt 3 to output or deposit the collected sand into a sandbag 5, the machine further featuring a collapsible sewing table conveyor belt 6 that may be stored within the spatial dimensions of the frame structure of the filling machine 1 or may be stood or placed apart from the frame structure and operated so to receive sand in sandbags placed on the sewing table conveyor belt 6.

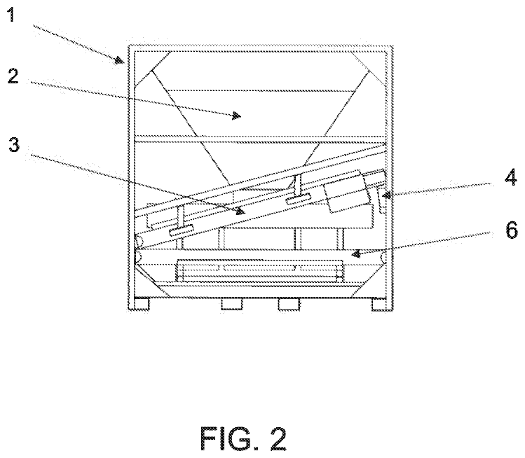

FIG. 2 is a front view of the portable sandbag filling machinery apparatus according to an exemplary, depicting the sandbag filling machine in a retracted, packed configuration to minimize volume and minimize risk for structural damage in storage or transport. In FIG. 2, the portable sandbag filling machine 1 features a frame structure that supports an input hopper 2 for receiving sand, a retracted conveyor belt 3 that would receive and transport the sand provided through input hopper when operating, a conical siphon or spout 4 that collects sand input from the retractable conveyor belt 3 to output or deposit the collected sand when in operation, the machine further featuring a collapsible sewing table conveyor belt 6 stored within the spatial dimensions of the frame structure of the filling machine 1 to facilitate storage and transport.

As depicted in FIG. 1, in a preferred embodiment of the invention, the input hopper 2 has a ventral (bottom) opening or aperture of at least 10 inches by 18 inches in size. These dimensions are large enough to reduce the likelihood of sand in the hopper creating bridges of sand across the opening that may block the opening.

As depicted in FIG. 1, in a preferred embodiment of the invention, the sewing table conveyor belt 5 features an in-line sewing machine that allows the machine operator to sew individual bags closed as they progress along the conveyor belt 6, preferably at a rate that match the machine's rate of filling the sandbags. In a preferred embodiment, this rate of filling sandbags is one bag for every two seconds. In another preferred embodiment, the rate at which the in-line sewing machine can sew is to sew closed a sandbag every two seconds.

In a preferred embodiment of the invention, the sandbag filling machine apparatus is small enough to entirely fit within a standard shipping container for transport or storage. In a preferred embodiment, the sandbag filling machine apparatus has a suitable height, width, and length compact enough to be handled in the LTL network. Specifically, a preferred embodiment of the machine apparatus will not be larger than 7′8″, so as to fit inside all LTL network shipping trucks (box trucks) and fit under the rollup doors commonly featured on such trucks. A preferred embodiment of the machine apparatus will not have a width greater than 8′, so as to be able to fit inside an LTL network shipping truck. A preferred embodiment of the machine apparatus will have a length no longer than 4′, so as to be available for handling by pallet jack and standard forklift and so thereby to avoid special freight handling charges. In sum, a preferred embodiment of the portable sandbag filling machine apparatus, when collapsed and configured for storage and transport, will feature dimensions of 7′ height, 7′ width, and 4′ length.

While developing a sandbag filling system suitably compact enough to meet the strict size limits for handling and transport in the LTL network, these size restraints run in opposition to the need for conveyors and gravity-fed hoppers in a sandbag filling system to allow for vertical and/or horizontal movement (and space) for each step of the sandbag filling process. Specifically, as depicted in FIG. 1, in a preferred embodiment of the invention, sand is dumped into the hopper 2 at the very top of the machine 1. The sand then works its way down through the hopper to an opening at the bottom. The larger the hopper, and the larger the capacity of the hopper, the greater vertical height and space is required for this aspect of the process.

As depicted in FIG. 1, from the bottom (ventral) opening of the hopper 2, in a preferred embodiment of the invention, the sand drops to a primarily horizontal conveyor sand feeder belt 3 that will feed the sand through a spout 4 and into an open sandbag 5 as it drops off of the distal end of the belt. The longer that this conveyor sand feeder belt 3 is, the greater the capacity of sand that it may process, and thus the greater the vertical height and larger the size and capacity that the hopper 2 can be.

As depicted in FIG. 1, in a preferred embodiment, the sand feeder conveyor belt 3 will feature a slight incline to allow for additional vertical height; in a particular preferred embodiment, the incline of the sand feeder conveyor belt 3 will be 15 degrees. However, the incline should not exceed 15 degrees, as a greater degree of inclination requires use of a non-smooth conveyor belt to avoid sand or other aggregate materials from sliding backwards on the belt when the incline exceeds 15 degrees. Use of a non-smooth conveyor belt can produce inconsistent sandbag weight upon being filled and thus is sought to be avoided in more preferred embodiments.

As depicted in FIGS. 1 and 2, in a preferred embodiment, the sand feeder conveyor belt 3 is retractable and extendable to allow for greater length and greater vertical height when deployed (while remaining compact enough for LTL storage and transport when retracted). In a preferred embodiment, the sand feeder belt 3 uses a track and roller system to alternatively deploy and retract the sand feeder conveyor belt 3. In another preferred embodiment, the sand feeder conveyor belt 3 uses a pendulum system to deploy and retract the sand feeder conveyor belt 3. In a most preferred embodiment, the sand feeder conveyor belt 3 is a full 7′ in length (the maximum allowable within the within the width of a LTL network box truck) so to allow the greatest vertical height in the sandbag filling system when deployed. When deployed, the sand feeder belt 3 can pop out approximately 24″ and raise the working vertical height of the system by about 10″ as an aspect of this most preferred embodiment. As a consequence of this lengthened sand feeder belt 3 extending 24″, the size and capacity of the feeding hopper 2 can be maximized (yet still meet the size restrictions for use in the LTL network) as a most preferred embodiment of the invention.

As depicted in FIG. 1, in a preferred embodiment, sand transported across the sand feeder belt 3 will fall from the distal end and will be funneled into an open sandbag 5 through a funnel or spout 4. In a preferred embodiment, the open sandbag 5 itself must fit under the spout 4 and above a horizontal sewing table 6 so that the sandbag 5 does not touch the table, and instead dangles from the spout 4, through the use of bag clamps, so that the bag might be properly and fully filled, and not pulled by the conveyor of the horizontal sewing table 6 until the bag is properly filled and then released.

Further as depicted in FIG. 1, in a preferred embodiment, the open sandbags 5 to be filled may be placed above a lower horizontal sewing table conveyor belt 6 above the ground, in such manner that the sandbags, once filled and released, may be moved along on the conveyor belt 6 to be sewn, glued, tied or sealed closed to be readied for use or transport. As depicted in FIG. 2, in a particular preferred embodiment of the invention, this lower horizontal sewing table 6 may be collapsed and stowed under the feeder conveyor belt inside the machine frame for stowage and transport to save room, and, as depicted in FIG. 1, this same sewing table 6 may also be expanded and set up below the machine spout 4 under working operations to receive sand in open sandbags 5 placed thereon.

In a most preferred embodiment of the invention, an in-line sewing machine will be located at or proximal to the horizontal sewing table conveyor 6, so that an operator can sew shut filled sandbags that are processed by the sandbag filling machine.

In a preferred embodiment of the invention, the sandbag filling machine can be set up for production without the necessity for use of tools.

As depicted in FIG. 1, in a preferred embodiment of the method of the invention, sand for filling sandbags will be introduced to a portable sandbag filling machine 1 featuring a frame structure that supports an input hopper 2 for receiving sand. Further, in the preferred method, sand will be placed into the input hopper 2, further wherein gravity will direct sand to flow through and down the hopper to exit at a bottom ventral opening in the hopper 2, whereupon the sand will land upon a retractable conveyor belt 3 that receives and transports the sand across its length, whereupon sands falls off of the far end of the conveyor belt, through a conical funnel or spout 4 that collects sand input from the retractable conveyor belt 3 to output or deposit the collected sand into an open sandbag 5 on a receiving horizontal conveyor belt sewing table 6, whereupon which the open bag may be sewn, glued, sealed or otherwise closed to prepare the filled sandbag for use, transport, or storage. In a particular preferred embodiment of the method of the invention, the filled sandbag is run through an operating in-line sewing machine and sewn shut upon the horizontal sewing table 6.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A portable sandbag filling machine apparatus comprising:
a frame structure that supports a hopper to receive sand, a retractable conveyor belt apparatus that may be configured so as to be stored and to be operable beneath the sand output from the hopper during the sandbag filling machine, a funnel to receive sand output from the conveyor belt apparatus, a sewing table with conveyor belt, wherein the sewing table may be placed below the funnel to receive sand into sandbags, further wherein the sandbag filling machine may be placed to provide room and operated such that sandbags may be sewn closed on the sewing table conveyor belt.

2. The portable sandbag filling machine apparatus of claim 1, wherein the ventral opening of the hopper is at least 10 inches by 18 inches in size.

3. The portable sandbag filling machine apparatus of claim 2, wherein the machine is sized and configured such that the machine may be placed in a shipping container or truck trailer for transport.

4. The portable sandbag filling machine apparatus of claim 3, wherein the retractable conveyor belt is 7 feet long.

5. A method for filling sandbags, comprising:
placing sand in a conical hopper secured within a structural frame, wherein the conical hopper that a ventral exit opening of a size of at least 10″×18″, wherein sand exits the ventral opening of the hopper to land on a conveyor that moves sand toward a sandbag, wherein the conveyor moves the sand to one end of the conveyor so that the sand falls from the conveyor, wherein there is a conical funnel or spout below the end of the conveyor such that the sand falling from the conveyor passes through the conical spout to a open sandbag below the spout, further wherein the open sandbag is placed upon a horizontal conveyor belt table, such that a filled open sandbag may be moved to allow the sandbag to be sealed.

6. The method of claim 5, wherein the horizontal conveyor belt table is suitably collapsible so as to be able to be stored within the bounds of the structural frame for storage or transport.

7. The method of claim 6, wherein the filled open sandbag is sealed via an in-line sewing machine.
